(19) United States
(12) Patent Application Publication
(10) Pub. No.: US 2016/0379254 A1
(43) Pub. Date: Dec. 29, 2016

(54) METHOD AND SYSTEM FOR ENABLING REAL TIME LOCATION BASED PERSONALIZED OFFER MANAGEMENT

(71) Applicant: Wipro Limited, Bangalore (IN)

(72) Inventors: Satyajit RAY, Cuttack (IN); Anindito DE, Chennai (IN)

(73) Assignee: Wipro Limited

(21) Appl. No.: 14/842,887

(22) Filed: Sep. 2, 2015

(30) Foreign Application Priority Data
Jun. 29, 2015 (IN) 3315/CHE/2015

(51) Int. Cl. G06Q 30/02

(52) U.S. Cl. CPC G06Q 30/0255; G06Q 30/0261; G06Q 30/0246

(57) ABSTRACT

The present disclosure relates to a method and a system for enabling real time location based personalized offer management to a customer. In one embodiment, the method identifies a plurality of customers likely visiting the store, and determines a plurality of relevant personalized bars that can be provided to the identified customers. Th.e method further receives real time information about the presence of customers within the store and provides the in-store customers with one or more real time recommendations of offers on products based on the usage of the relevant personalized offers. Thus, the method and system provides personalized promotional offer based on convenience of individual customers, customers interest on different products on real-time within the establishment. Further, the method and system also provides alternate offers to customers present within store and assess the promotional effectiveness of the campaign on a real-time basis.

### PRIORITY CLAIM

This U.S. patent application claims priority under 35 U.S.C. §119 to India Application No. 3315/CHE/2015, filed Jun. 29, 2015. The entire contents of the aforementioned application are incorporated herein by reference,

### FIELD OF THE DISCLOSURE

The present subject matter is related, in general to offer management system, and more particularly, but not exclusively to method and a system for enabling real time location based personalized offer management.

### BACKGROUND

Generally, businesses and establishments such as retail stores often has a need to accurately record the identity of customers or visitors for marketing, and seek to encourage repeat customers and habitual shopping by customers. One way in which merchants have encouraged repeat business by introducing campaign offers to attract new customers and retain the existing customers. These offers are based on product-category, buying patterns and so on and sent to a set of identified customers in groups at regular intervals. Some of the customers make use of these offers whereas some customers do not use the offers. Conventional offer personalization techniques fail to identify whether the customer is really visiting the store or already visited the store but not been captured or recorded as customer. Thus, the existing mechanism does not identify target customers on a real-time basis. Furthermore, existing technologies fails to provide offers to the consumers (customers or potential customers) who are likely to visit the store in near future. The offers are customized for particular customer-segments and may not be appropriate for individual customers. Conventional mechanisms do not involve customer convenience in terms of time, location, movement, etc. and hence leads to ineffective campaign (wrong timing and less relevant offer). Still further, conventional campaign techniques also fail to identify customer who visited the store but did not take advantage of the offer.

Conventional campaign promotion effectiveness is assessed by analysing the sale information by relating with the product & customer segment information and performed on the historic sale data. However, existing mechanisms fail to provide alternate offers to in-store customers based on the assessment of campaign promotion effectiveness in real time. Therefore, there is a need for method and system for enabling real time location based personalized offer management and overcoming the disadvantages and limitations of the existing systems.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Accordingly, the present disclosure relates to a method of enabling real time location based personalized offer management to a customer. The method comprising the step of identifying a plurality of potential customers likely visiting an establishment and creating a segregated customer data (SCM) associated with the plurality of potential customers. The SCM comprises historical data of one or more buying patterns (BP) and the one or more areas of interests associated with the plurality of potential customers. The method further comprises the steps of determining a plurality of relevant personalized offers (RPO) based on mapping of the plurality of personalized offers with the SCM. Upon determining the plurality of RPO, information associated with presence of the plurality of potential customers within the establishment is received dynamically from an external device, based on current location (CL) of the plurality of potential customers. For the plurality of potential customers present within the establishment, one or more real time recommendations are generated based on one or more buying patterns and offer acceptance to the plurality of relevant personalized offers made to the plurality of potential customers.

Further, the present disclosure relates to a system for enabling real time location based personalized offer management to a customer. The system comprises a processor and a customer data repository coupled with the processor. The customer data repository stores segregated customer data (SCM) comprising historical data of one or more buying patterns (BP) and the one or more areas of interests of the plurality of potential customers. The system further comprises a memory communicatively coupled with the processor, wherein the memory stores processor-executable instructions, which, on execution, cause the processor to identify a plurality of potential customers likely visiting an establishment and create the segregated customer data (SCM) associated with the plurality of identified potential customers. The processor is further configured to map a plurality of personalized offers applicable on one or more products with the SCM and determine the plurality of personalized offers (RPO) based on mapping with the SCM. Upon determining the plurality of RPO, the processor is configured to receive dynamically information associated with presence of the plurality of potential customers within the establishment from an external device, based on current location. (CL) of the plurality of potential customers. The processor is further configured to generate one or more real time recommendations of offer to the plurality of potential customers present within the establishment, based on one or more buying patterns and offer acceptance to the plurality of relevant personalized offers made to the plurality of potential customers,

Furthermore, the present disclosure relates to a non-transitory computer readable medium including instructions stored thereon that when processed by at least one processor cause a system to perform the act of identifying a plurality of potential customers likely visiting an establishment and creating a segregated customer data (SCM) associated with the plurality of identified potential customers, wherein the SCM comprises historical data of one or more buying patterns (.3P) and the one or more areas of interests of the plurality of potential customers. Further, the instructions cause the processor to map a plurality of personalized offers applicable on one or more products with the SCM and determine the plurality of personalized offers (RPO) based on mapping with the SCM. The processor is also configured to receive dynamically information associated with presence of the plurality of potential customers within the establishment from an external device, based on current location (CL) of the plurality of potential customers. The processor is further more configured to generate one or more real time recommendations of offer to the plurality of potential customers present within the establishment, based on one or more buying patterns and offer acceptance to the plurality of relevant personalized offers made to the plurality of potential customers.

The foregoing summary is illustrative only and is not intended, to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an architecture diagram of an exemplary system for enabling real time location based personalized offer management to a customer in accordance with some embodiments of the present disclosure;

FIG. 2 illustrates an exemplary block diagram of an offer management system of FIG. 1 in accordance with some embodiments of the present disclosure;

FIG. 3 illustrates a flowchart of an exemplary method of enabling real time location based personalized offer management to a customer in accordance with some embodiments of the present disclosure;

FIG. 4 is a block diagram of an exemplary computer system for implementing embodiments consistent with the present disclosure,

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown,

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

The present disclosure relates to a method and a system for enabling real time location based personalized offer management to a customer. In one embodiment, the method identifies a plurality of customers likely visiting the store, and determines a plurality of relevant personalized offers that can be provided to the identified customers. The method further receives real time information about the presence of customers within the store and provides the in-store customers with one or more real time recommendations of offers on applicable products. Thus, the method and system provides personalized promotional offer based on convenience of individual customers, customers interest on different products on real-time within the establishment. Further, the method and system also provides alternate offers to customers present within store and assess the promotional effectiveness of the campaign on a real-time basis.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

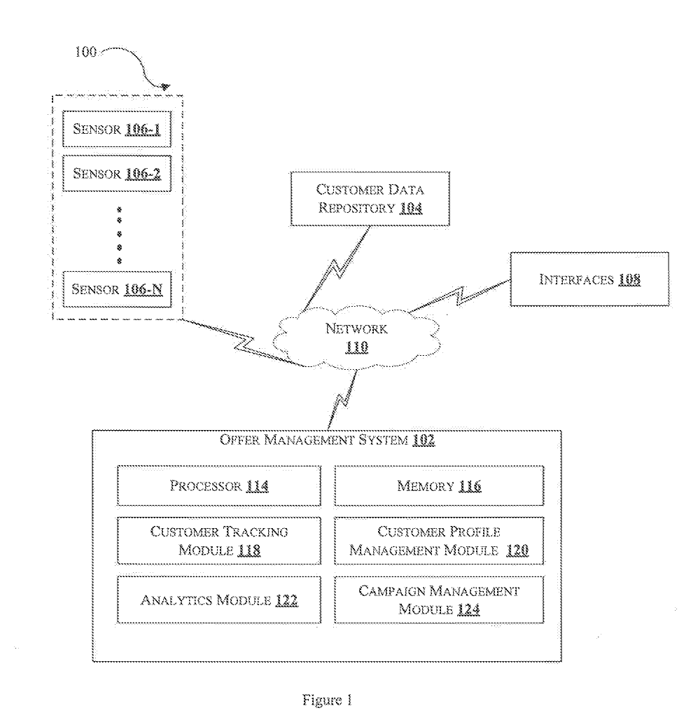

FIG. 1 illustrates an architecture diagram of an exemplary system for enabling real time location based personalized offer management to a customer in accordance with some embodiments of the present disclosure.

As shown in FIG. 1, the exemplary system 100 comprises one or more components configured for enabling real time location based personalized offer management to a customer. In one embodiment, the exemplary system 100 comprises an offer management system (OMS) 102, a customer data repository 104, one or more sensors 106-1, 106-2, . . . , 106-N (collectively referred to as sensors 106) and one or more interfaces 108 connected via a communication network 110.

The sensors 106 may be for example, beacons or Bluetooth low energy (BLE) enabled devices that communicate via radio waves located at different locations within the store. The store may be a retail shop, malls, etc., that has a predefined store layout (SL) stored in the customer data repository 104. The sensors 106 are configured to collect data.

associated with the presence of plurality of potential customers within the store based on which contextual information and advertisements offered by the store may be transmitted onto devices associated with the plurality of customers. In one embodiment, the sensors 106 identify the presence of plurality of customers within the store and transmit the presence information to the OMS 102. Upon receiving the information, the OMS 102 determines the current location of the plurality of customers within the store and determines a plurality of relevant personalized offers available within the store based on historical buying patterns and areas of interests of the plurality of customers stored in the customer data repository 104.

The one or more interfaces 108 may interact with one or more devices like camera, locating devices like GPS and so on and determine facial identity and current location of the plurality of customers. In one embodiment, the one or more interfaces include, for example a Communication interface/sensor (Com-I) and a proximity interface/sensor (Pro-I) to determine the current location when the plurality of customers are located respectively at outside the store and within the store. The one or more interfaces may also include, for example a Cam-I for enabling capturing of facial images of the plurality of customers present within the store to identify old and new customers. The Pro-I determines the presence of one or more customers located nearby based on one or more signals received from the mobile devices associated with the one or more customers, Cam-I captures the facial images of the customers whose presence is determined and compares the captured facial images with one or more images of old customers previously stored in the customer data repository 104 and identify old and new customers based on the comparison. If one or more new customers are identified, then the OMS 102 register them as the plurality of customers and continue sending them the plurality of relevant personalized offers.

In one embodiment, the OMS 102 comprises a central processing unit (“CPU” or “processor”) 114, and a memory 116 coupled with the processor 114. The OMS 102 comprises a customer tracking module (CTM) 118 configured to track the plurality of customers inside and outside the store or establishment. In one embodiment, the CTM 118 receives information associated with the presence of the plurality of customers outside and within the store from the interfaces 108 via the network 110 and identifies or locates the plurality of customers based on the received information. The OMS 102 further comprises a customer profile management (CPM) module 120 configured to manage information associated with the plurality of customers by creating one or more customer profiles, update the one or more customer profiles based on updated information received therein. The CPM 120 also generates segregated customer data (SCM) that comprises historical data of one or more buying patterns (BP) and the one or more areas of interests associated with the plurality of customers.

The OMS 102 further comprises an analytical module (AM) 122 and a campaign management module (CMM) 124. The AM 122 is configured to perform analysis of historical data and real time data associated with the behavioral patterns of buying products and areas of interest of plurality of customers. Based on the analysis, the AM 122 determines one or more scores for example, product interest (PI) score and behavioral pattern (BP) score associated with the plurality of customers. Further, the AM 122 is configured to determine customer convenience (CC) score indicative of time, place, product and store convenient to the plurality of customers based on current location and product interest (PI) score of the plurality of potential customers along with past buying patterns and past customer activity including past movement patterns around the store and within the city. For example, a customer who commutes in a particular route will get an offer for a store in his commute route two hours before he starts the commute. In another example, a person who visits a mall sometimes on Saturday afternoon will get an offer if he is within 3 miles of the mall on a Saturday afternoon. Furthermore, the AM 122 is configured to determine possibility of store visit (PSV) by the plurality of customers and one or more PSV scores associated with the determined probability of store visit based on real time current location and current activity information associated with the plurality of customers.

The CMM 124 is configured to manage campaign on segregated customers by offering the segregated customers with the plurality of relevant personalized offers (RPO). In one embodiment, the CMM 124 is configured to determine the plurality of RPO and generate an offer delivery schedule (ODS) personalized in accordance with the determined plurality of RPO. Further, the CMM 124 is configured to determine the presence of the plurality of customers within the store, determine offer usage score (OU) of the plurality of RPO by the plurality of customers and provide real time recommendations of offers to the plurality of customers. In one embodiment, the real time recommendations of offers include a plurality of alternate offers available on the one or more products of interest to the plurality of customers who visited the store. In one example, once a customer who received an offer outside the store arrives at the store, he is recognized and provided with more content based on previous offer and other personalized attributes.

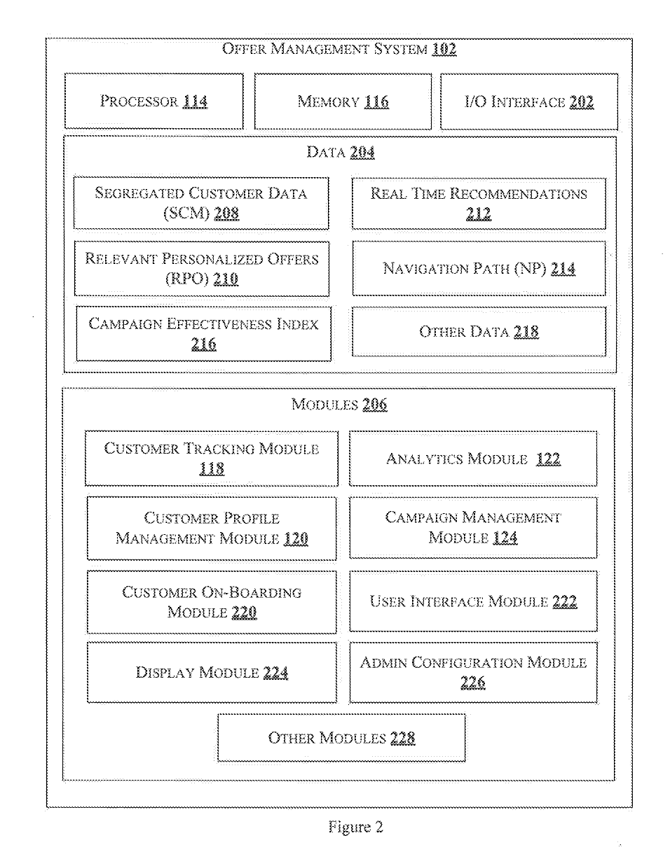

The OMS 102 may be a typical offer management system as illustrated in FIG. 2. The OMS 102 comprises the processor 114, the memory 116 and an I/O interface 202. The I/O interface 202 is coupled with the processor 114 and an I/O device. The I/O device is configured to receive inputs via th.e I/O interface 202 and transmit outputs for displaying in the I/O device via the I/O interface 202. The OMS 102 further comprises data 204 and modules 206. In one implementation, the data 204 and the modules 206 may be stored within the memory 116. In one example, the data 204 may include SCM 208, plurality of relevant personalized offers (RPO) 210, real time recommendations 212, navigation path (NP) 214, campaign effectiveness index (CEI) 216 and other data 218. In one embodiment, the data 204 may be stored in the memory 116 in the form of various data structures. Additionally, the aforementioned data can be organized using data models, such as relational or hierarchical data models. The other data 21.8 may be also referred to as reference repository for storing recommended implementation approaches as reference data. The other data 218 may also store data, including temporary data and temporary files, generated by the modules 206 for performing the various functions of the OMS 102.

The modules 206 may include, for example, the CTM 118, the CPM 120, the AM 122, the CMM. 124, a customer on-boarding module (COM) 220, a user interface module (UIM) 222, a display module 224 and an admin configuration module (ACM) 226. The COM 220 is configured to create one or more customer records (CR) for the plurality of customers who have visited the store and stores the one or more customer records in the customer data repository 104. One or more customer records (CR) comprise a plurality of responses corresponding to a plurality of predefined questions related to areas of interest of the plurality of customers. The COM 124 enables the AM 122 to determine a relationship index (RI) indicative of as to whether the plurality of customers who have currently visited the store is either a new customer or an old customer. The COM 124 is further configured to create SCM 208 corresponding to the one or more CR.

The ACM 226 is configured to perform administration and configuration of the CMM 124 and also maintains campaign configuration data using the UIM 222. The UIM 222 provides one or more interfaces to one or more authorized customers to enable performing configuration and administration functions on ACM 226. The display module 224 also alternatively referred to as dashboard displays information about customer activities, customer location and campaign related information. The display module 224 retrieve information associated with the customer such as the customer activities and customer location from the customer data repository 104 and displays to the customers. The display module 224 also displays the status and one or more ongoing processing of the modules 206.

The modules 206 may also comprise other modules 228 to perform various miscellaneous functionalities of the OMS 102. It will be appreciated that such aforementioned modules may be represented as a single module or a combination of different modules. The modules 206 may be implemented in the form of software, hardware and/or firmware.

In operation, the OMS 102 determines a plurality of RPO 210 for each SCM 208 of the plurality of customers who may likely visit the store in the near future. In one embodiment, the CTM 118 tracks the plurality of customers who are potential customers based on their frequency of visits to the store. In one embodiment, the CTM 118 tracks a visitor visiting the store and determines as to whether the visitor is an existing customer or repeat-visitor. The CTM 118 enables the Pro-I and Cam-I interfaces to obtain the presence of one or more customers located nearby based on one or more signals received from the mobile devices associated with the one or more customers and facial identity image of the visitor and compares the facial identity (FI) image of the visitor with a plurality of images previously captured and stored in the customer data repository 104. If it is determined that the FI image of the visitor does not match with any of the plurality of stored FI images, then the CTM 118 determines that there is no corresponding CR and enables the COM 220 to create a new CR for the visitor. In one embodiment, the COM 220 creates the new CR for the visitor by providing the plurality of predefined questions obtained from the customer data repository 104 to the visitor and storing the plurality of responses made by the visitor corresponding to the plurality of predefined questions in the new CR. Upon creating the new CR, the COM 220 calculates the relationship index (RI) indicative of probability of the visitor becoming a customer with the store. In one implementation, the AM 122 evaluates the plurality of visitor responses and assigns a rating to each of the plurality of visitor responses thus evaluated. The AM 122 calculates the RI using the rating and compares the calculated RI with a predetermined relationship index (RI) threshold value and determines the visitor to become a potential customer based on the comparison. Upon creating the new CR, the AM 122 creates a corresponding SCM 208 for the visitor.

Otherwise, if the FI image of the visitor matches with at least one of the stored FI images, then the CPM 120 retrieves the matching CR from the customer data repository 104 and determines the SCM 208 corresponding to the matching CR. The SCM 208 comprises historical data of one or more buying patterns (BP) and the one or more areas of interests associated with the plurality of potential customers. The CMM 124 then determines the plurality of relevant personalized offers (RPO) 210 associated with the SCM 208. In one embodiment, the CMM 124 retrieves the plurality of personalized offers from the customer data repository 104 and performs mapping of the retrieved plurality of personalized offers with the SCM 208 i,e,, one or more buying patterns and areas of interests of the plurality of customers to determine the plurality of RPO 210. Upon determining the plurality of RPO 210, the CMM 124 determines an offer delivery schedule (ODS) comprising the plurality of RPO 210 that may be communicated to the plurality of customers based on customer convenience and probability of visiting the store. The plurality of customers may receive the ODS and may likely visit the store if they wish to avail the plurality of RPO 210 available in the ODS.

In one embodiment, the CMM 124 determines the ODS based on the customer convenience (CC) and probability of the plurality of customers visiting the store. In one implementation, the CMM 124 determines the CC score for each of the SCM 208 associated with the plurality of customers based on the one or more buying patterns (BP) and product interest (PI) score of the plurality of customers. The CMM 124 determines the BP and PI score based on the one or more customer activities (CA) and current location (CL). Further, the CMM 124 retrieves historical BP and PI score associated with the plurality of customers and determines the CC score based on the comparison of the historical BP and PI score respectively with the determined BP and PI score. The CMM 124 further determines the probability of the plurality of customers visiting the store.

In one implementation, the CMM 124 determines the possibility of store visit (PSV) score associated with the plurality of customers based on the real time customer activities CA and historical BP and PI score. The real time customer activities may he for example, movement of the customer towards the store or through the store location. The CMM 124 compares the determined PSV score with a predetermined possibility of store visit threshold (PSVT) value stored in the customer data repository 104. Based on the comparison, the CMM 124 identifies the plurality of potential customers likely visiting the store. For each of the SCM 208 associated with the plurality of identified potential customers likely visiting, the store, the CMM 124 generates the ODS based on the CC and PSV scores and RPO and transmit the generated ODS to the plurality of identified potential customers. Upon generating the ODS, the CMM 124 updates the SCM 208 of the plurality of customers with the ODS, RPO, CC and PSV scores. The plurality of customers who have received the ODS may visit the store and avail the offer as indicated in the ODS. The OMS 102 identify the plurality of customers with ODS visiting the store and may offer with real time recommendations on the offers.

In one embodiment, the OMS 102 determines the presence of the plurality of customers within the store who has received the ODS and recommend the plurality of customers in real time with one or more recommendations on offers based on the in-store movement, buying pattern and areas of interest. In one embodiment, the CTM 118 determines the presence of plurality of customers with received ODS based on the facial identity FI and the presence of one or more customers located nearby based on one or more signals received from the mobile devices associated with the one or more customers captured by the Pro-I and Cam-I interfaces located at one or more locations within the store. Based on the captured FI, the CTM 118 determines the CR associated with the captured FI and retrieves the SCM 208 associated with the CR thus determined. The CMM 124 determines store visit information (SVI) for each SCM 208 in real time and determines the presence of the plurality of customers with ODS within the store based on the real time SVI. For example, SVI may be associated with information including number of visits of the plurality of customers to the store, frequency of the visit, date and time of the visit, shopping cart details in individual visit and so on. Upon determining the presence of the plurality of customers with ODS within the store, the OMS 102 provides navigational assistance to the plurality of customers to reach out to the one or more products with the offer as indicated in the ODS.

In one embodiment, the CMM 124 determines SVI from the SCM 208 associated with the plurality of customers within the store and further determines accurate location of the one or more products available with offer in ODS based on the store layout SL of the store. The AM 122 determines the navigational path (NP) 214 that enables the plurality of customers to reach out to the one or more products from the current location of the plurality of customers. In one implementation, the AM 122 determines the NP 214 based on the SVI and accurate location of the one or more products. Upon determination of the NP 214, the AM 122 enables the Pro-I interface to display the. NP 214 on one or more devices of the plurality of customers. In one example, the one or more devices may be a mobile handset. Upon providing the navigational assistance to the plurality of customers by displaying the NP 214, the OMS 102 tracks the in-store movement of the plurality of customers and determines usage of offer in ODS by the plurality of customers.

In one embodiment, the CTM 118 tracks and provides the in-store movement of the plurality of customers to the CMM 124. The CMM 124 determines one or more CA that based on the tracked in-store movement of the plurality of customers and the predefined store layout SL. For example, CA indicates the movements of the plurality of customers towards one or more products within the store, buying decisions of the one or more products and so on. On determining the one or more CA, the CMM 124 determines offer usage (OU) based on the one or more CA and the one or more offers available in the ODS. In one embodiment, the CMM 124 compares the one or more CA with the one or more ODS offers to determine whether the plurality of customers have availed the offer. If the CMM 124 determines that the plurality of customers have availed the offer in ODS, then an OU score is set to a predetermined value say for example 100. The CMM 124 determines the OU by calculating the OU score for each of the one or more products bought by the plurality of customers. Upon determining the OU, the OMS 102 tracks the behavior pattern (.BP) and areas of interest to the plurality of customers and determines the one or more real time recommendations 212 that may be provided to the plurality of customers based on tracked BP and areas of interest.

In one implementation, the CMM 124 determines real time BP and areas of interest to the plurality of customers. The CMM 124 obtains one or more CA determined by the CTM 118 and analyses the one or more determined CA and the historical/past BP stored in the customer data repository 104. Based on the analysis, the CMM 124 determines the real time BP. The CMM 124 further obtains one or more CA determined by the CTM 118 and analyses the one or more determined CA and the historical/past PI score stored in the customer data repository 104. Based on the analysis, the CMM 124 determines the real time areas of interest having high PI score. Based on the OU, real time BP and areas of interest, the CMM 124 determines the one or more real time recommendations 212 to be offered to the plurality of customers. One or more real time recommendations 212 may include, for example, one or more alternate offers on one or more products of interest to the plurality of customers that were not available in the ODS. The CMM 124 enables the Pro-I interface to display the one or more alternate offers (AO) on one or more devices of the plurality of customers.

The OMS 102 also calculates the campaign effectiveness index (CEI) 216 indicative of how the campaign was effective and need for improving the campaign effectiveness. In one embodiment, the CMM. 124 computes the CEI 216 based on the CA, SVI, OU and AO, PI score, RI, and CC score of each SCM associated with the plurality of customers. Upon computing the CEI 216, the CMM 124 compares the computed CEI 216 with a predetermined threshold campaign effectiveness index (CEIT) and modifies the SCM 208 based on the comparison. In one embodiment, if the computed CEI 216 is determined to be lower than the CEIT, then the CMM 124 updates the SCM 208 based on one or more new areas of interest and one or more AO this availed by the plurality of customers.

In one implementation, the CMM 124 identifies the one or more new areas of interest to the plurality of customers based on the CA, OU of RPO and usage of AO and computes a new PI score based on the identified new areas of interest. The CMM 124 compares the new PI score with the PI score associated with the SCM 208 and based on the comparison, determines one or more relevant new RPO and AO corresponding to the new areas of interest. The CMM 124 updates the SCM 208 with the computed CEI 216, new PI score, new areas of interest and one or more relevant new RPO and AO thus determined. The updated SCM 208 now indicates the updated areas of interest and corresponding RPO and AO that the plurality of customers may wish to receive in future.

Thus, the system 100 enables the plurality of customers with personalized promotional offer in real time based on convenience and areas of interest. The system 100 also assesses the campaign effectiveness in real time and dynamically reconfigures the customer data based on the assessment.

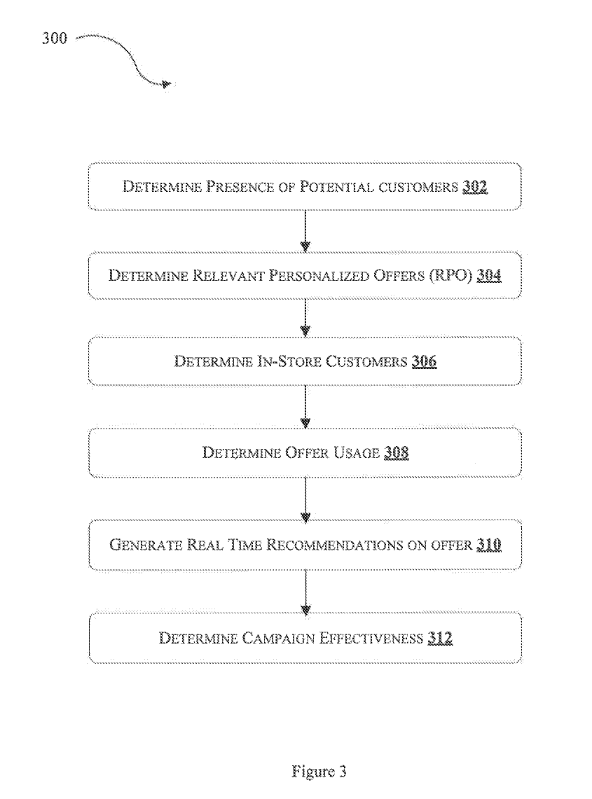

FIG. 3 illustrates a flowchart of a method of enabling real time location based personalized offer management to a customer in accordance with some embodiments of the present disclosure.

As illustrated in FIG. 3, the method 300 comprises one or more blocks implemented by the processor 114 for enabling real time location based personalized offer management to a customer. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method 300. Additionally, individual blocks may be deleted from the method 300 without departing from the spirit and scope of the subject matter described herein. Furthermore, the method 300 can be implemented in any suitable hardware, software, firmware, or combination thereof

At block 302, determine presence of potential customers. In one embodiment, the OMS 102 determines a plurality of RPO 210 for each SCM 208 of the plurality of customers who may likely visit the store in the near future, in one embodiment, the CTM 118 tracks the plurality of customers who are potential customers based on their frequency of visits to the store, in one embodiment, the CTM 118 tracks a visitor visiting the store and determines as to whether the visitor is an existing customer or repeat-visitor. The CTM 118 enables the Pro-I and Cam-I interfaces to obtain the presence of one or more customers located nearby based on one or more signals received from the mobile devices associated with the one or more customers and facial identity image of the visitor and compares the facial identity (FI) image of the visitor with a plurality of H images previously captured and stored in the customer data repository 104. If it is determined that the FI image of the visitor does not match with any of the plurality of stored FI images, then the CTM 118 determines that there is no corresponding CR and enables the COM 220 to create a new CR for the visitor. In one embodiment, the COM 220 creates the new CR for the visitor by providing the plurality of predefined questions obtained from the customer data repository 104 to the visitor and storing the plurality of responses made by the visitor corresponding to the plurality of predefined questions in the new CR. Upon creating the new CR, the COM 220 calculates the relationship index (RI) indicative of probability of the visitor becoming a customer with the store.

In one implementation, the AM 122 evaluates the plurality of visitor responses and assigns a rating to each of the plurality of visitor responses thus evaluated. The AM 122 calculates the RI using the rating and compares the calculated RI with a predetermined relationship index (RI) threshold value and determines the visitor to become a potential customer based on the comparison. Upon creating the new CR, the AM 122 creates a corresponding SCM 208 for the visitor. Otherwise, if the FI image of the visitor matches with at least one of the stored FI images, then the CPM 120 retrieves the matching CR from the customer data repository 104 and determines the SCM 208 corresponding to the matching CR. At block 304, determine relevant personalized offers (RPO). In one embodiment, the CMM 124 determines the plurality of relevant personalized offers (RPO) 210 associated with the SCM 208. In one embodiment, the CMM 124 retrieves the plurality of personalized offers from the customer data repository 104 and performs mapping of the retrieved plurality of personalized offers with the SCM 208 i.e., one or more buying patterns and areas of interests of the plurality of customers to determine the plurality of RPO 210. Upon determining the plurality of RPO 210, the CMM 124 determines an offer delivery schedule (ODS) comprising the plurality of RPO 210 that may be communicated to the plurality of customers based on customer convenience and probability of visiting the store. The plurality of customers may receive the ODS and may likely visit the store if they wish to avail the plurality of RPO 210 available in the ODS.

In one embodiment, the CMM 124 determines the ODS based on the customer convenience (CC) and probability of the plurality of customers visiting the store. In one implementation, the CMM 124 determines the CC score for each of the SCM 208 associated with the plurality of customers based on the one or more buying patterns (BP) and product interest (PI) score of the plurality of customers. The CMM 124 determines the BP and PI score based on the one or more customer activities (CA) and current location (CL). Further, the CMM 124 retrieves historical BP and PI score associated with the plurality of customers and determines the CC score based on the comparison of the historical BP and PI score respectively with the determined UP and PI score. The CMM 124 further determines the probability of the plurality of customers visiting the store.

In one implementation, the CMM 124 determines the possibility of store visit (PSV) score associated with the plurality of customers based on the real time customer activities CA and historical BP and PI score. The real time customer activities may be for example, movement of the customer towards the store or through the store location. The CMM 124 compares the determined PSV score with a predetermined possibility of store visit threshold (PSVT) value stored in the customer data repository 104. Based on the comparison, the CMM 124 identifies the plurality of potential customers likely visiting the store. For each of the SCM 208 associated with the plurality of identified potential customers likely visiting the store, the CMM 124 generates the ODS based on the CC and PSV scores and RPO and transmit the generated ODS to the plurality of identified potential customers. Upon generating the ODS, the CMM 124 updates the SCM 208 of the plurality of customers with the ODS, RPO, CC and PSV scores. The plurality of customers who have received the ODS may visit the store and avail the offer as indicated in the ODS.

At block 306, determine in-store customers. In one embodiment, the OMS 102 determines the presence of the plurality of customers within the store who has received the ODS and recommend the plurality of customers in real time with one or more recommendations on offers based on the in-store movement, buying pattern and areas of interest. In one embodiment, the CTM 118 determines the presence of plurality of customers with received ODS based on the facial identity PI captured by the Pro-I and Cam-I interfaces located at one or more locations within the store. Based on the captured FI, the CTM 118 determines the CR associated with the captured FL and retrieves the SCM 208 associated with the CR thus determined. The CMM 124 determines store visit information (SVI) for each SCM 208 in real time and determines the presence of the plurality of customers with ODS within the store based on the real time SVI. Upon determining the presence of the plurality of customers with ODS within the store, the OMS 102 provides navigational assistance to the plurality of customers to reach out to the one or more products with the offer as indicated in the ODS.

In one embodiment, the CMM 124 determines SVI from the SCM 208 associated with the plurality of customers within the store and further determines accurate location of the one or more products available with offer in ODS based on the store layout SL of the store. The AM 122 determines the navigational path (NP) 214 that enables the plurality of customers to reach out to the one or more products from the current location of the plurality of customers. In one implementation, the AM 122 determines the NP 214 based on the SVI and accurate location of the one or more products. Upon determination of the NP 214, the AM 122 enables the Pro-I interface to display the NP 214 on one or more devices of the plurality of customers. At block 308, determine offer usage. In one embodiment, the OMS 102 determines the presence of the plurality of customers within the store who has received the ODS and recommend the plurality of customers in real time with one or more recommendations on offers based on the in-store movement, buying pattern and areas of interest. In one embodiment, the CTM 118 determines the presence of plurality of customers with received ODS based on the presence of one or more customers located nearby based on one or more signals received from the mobile devices associated with the one or more customers and the facial identity FI captured by the Pro-I and Cam-I interfaces located at one or more locations within the store. Based on the captured FI, the CTM 118 determines the CR associated with the captured FI and retrieves the SCM 208 associated with the CR thus determined. The CMM 124 determines store visit information (SVI) for each SCM 208 in real time and determines the presence of the plurality of customers with ODS within the store based on the real time SVI. Upon determining the presence of the plurality of customers with ODS within the store, the OMS 102 provides navigational assistance to the plurality of customers to reach out to the one or more products with the offer as indicated in the ODS.

In one embodiment, the CMM 124 determines SVI from the SCM 208 associated with the plurality of customers within the store and further determines accurate location of the one or more products available with offer in ODS based on the store layout SL of the store. The AM 122 determines the navigational path (NP) 214 that enables the plurality of customers to reach out to the one or more products from the current location of the plurality of customers. In one implementation, the AM 122 determines the NP 214 based on the SVI and accurate location of the one or more products. Upon determination of the NP 214, the AM 122 enables the Pro-I interface to display the NP 214 on one or more devices of the plurality of customers. Upon providing the navigational assistance to the plurality of customers by displaying the NP 214, the OMS 102 tracks the in-store movement of the plurality of customers and determines usage of offer in ODS by the plurality of customers.

In one embodiment, the CTM 118 tracks and provides the in-store movement of the plurality of customers to the CMM 124. The CMM 124 determines one or more CA that based on the tracked in-store movement of the plurality of customers and the predefined store layout SL. For example, CA indicates the movements of the plurality of customers towards one or more products within the store, buying decisions of the one or more products and so on. On determining the one or more CA, the CMM 124 determines offer usage (OU) based on the one or more CA and the one or more offers available in the ODS. In one embodiment, the CMM 124 compares the one or more CA with the one or more ODS offers to determine whether the plurality of customers have availed the offer. If the CMM 124 determines that the plurality of customers have availed the offer in ODS, then an OU score is set to a predetermined value say for example 100. The CMM 124 determines the OU by calculating the OU score for each of the one or more products bought by the plurality of customers.

At block 310, generate real time recommendations on offer. In one embodiment, the CMM 124 determines real time BP and areas of interest to the plurality of customers. The CMM 124 obtains one or more CA determined by the CTM 118 and analyses the one or more determined CA and the historical/past BP stored in the customer data repository 104. Based on the analysis, the CMM 124 determines the real time BP. The CMM 124 further obtains one or more CA determined by the CTM 118 and analyses the one or more determined CA and the historical/past PI score stored in the customer data repository 104. Based on the analysis, the CMM 124 determines the real time areas of interest having high PI score. Based on the OU, real time BP and areas of interest, the CMM 124 determines the one or more real time recommendations 212 to be offered to the plurality of customers. One or more real time recommendations 212 may include, for example, one or more alternate offers on one or more products of interest to the plurality of customers that were not available in the ODS. The CMM 124 enables the Pro-1 interface to display the one or more alternate offers (AO) on one or more devices of the plurality of customers.

At block 312, determine campaign effectiveness. In one embodiment, The OMS 102 calculates the campaign effectiveness index (CEI) 216 indicative of how the campaign was effective and need for improving the campaign effectiveness. In one embodiment, the CMM 124 computes the CEI 216 based on the CA, SVI, OU and AO, PI score, RI, and CC score of each SCM associated with the plurality of customers. Upon computing the CEI 216, the CMM 124 compares the computed CEI 216 with a predetermined threshold campaign effectiveness index (CEIT) and modifies the SCM 208 based on the comparison. In one embodiment, if the computed CEI 216 is determined to be lower than the CEIT, then the CMM 124 updates the SCM 208 based on one or more new areas of interest and one or more AO thus availed by the plurality of customers.

In one implementation, the CMM 124 identifies the one or more new areas of interest to the plurality of customers based on the CA, OU of RPO and usage of AO and computes a new PI score based on the identified new areas of interest. The CMM 124 compares the new PI score with the PI score associated with the SCM 208 and based on the comparison, determines one or more relevant new RPO and AO corresponding to the new areas of interest. The CMM 124 updates the SCM 208 with the computed CEI 216, new PI score, new areas of interest and one or more relevant new RPO and AO thus determined. The updated SCM 208 now indicates the updated areas of interest and corresponding RPO and AO that the plurality of customers may wish to receive in future,

Thus, the system 100 enables the plurality of customers with personalized promotional offer in real time based on convenience and areas of interest. The system 100 also assesses the campaign effectiveness in real time and dynamically reconfigures the customer data based on the assessment,

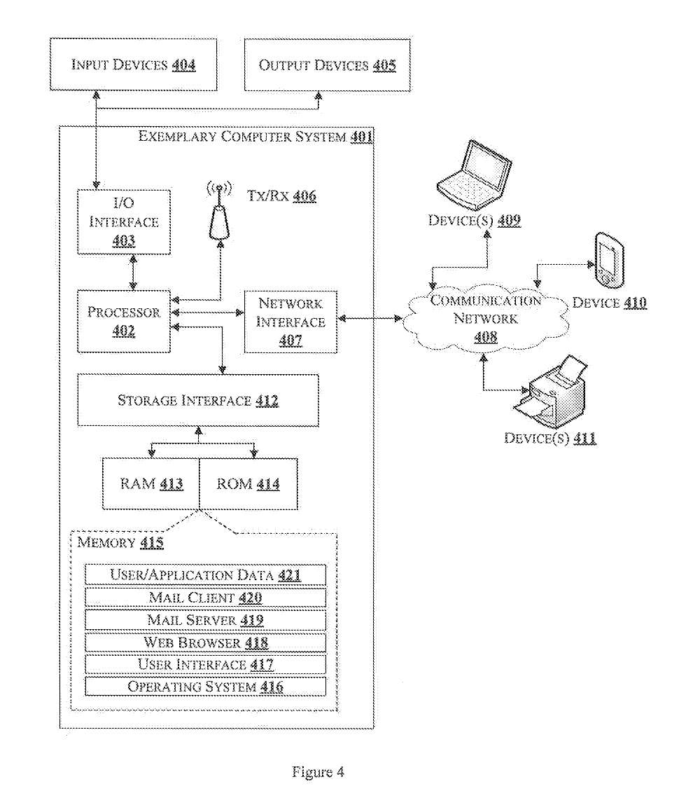

FIG. 4 is a block diagram of an exemplary computer system for implementing embodiments consistent with the present disclosure.

Variations of computer system 401 may be used for implementing all the computing systems that may be utilized to implement the features of the present disclosure. Computer system 401 may comprise a central processing unit (“CPU” or “processor”) 402. Processor 402 may comprise at least one data processor for executing program components for executing user- or system-generated requests. The processor may include specialized processing units such as integrated system (bus) controllers, memory management control units, floating point units, graphics processing units, digital signal processing units, etc. The processor 402 may include a microprocessor, such as AMD Athlon, Duron or Opteron, ARM's application, embedded or secure processors, IBM PowerPC, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LIE). WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna. operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (OPS), 2G/3G HSDPA/HSUPA communications, etc.

In some embodiments, the processor 402 may be disposed in communication with a communication network 408 via a network interface 407. The network interface 407 may communicate with the communication network 408. The network interface 407 may employ connection protocols including, without limitation, direct connect, Ethernet (e.g., twisted pair 10/40/400 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 409, 410, and 411. These devices may include, without limitation, personal computer(s), server(s), fax machines, printers, scanners, various mobile devices such as cellular telephones, smartphones (e.g., Apple iPhone, Blackberry. Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 402 may be disposed in communication with one or more memory devices (e.g., RAM 413, ROM 4Error! Reference source not found 14, etc.) via a storage interface 412. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 415 may store a collection of program or database components, including, without limitation, an operating system 4Error! Reference source not found. 16, user interface application 5Error! Reference source not found.17, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, UNIX, Unix-like system distributions (e.g., Berkeley Software Distribution (BSD), FreeBSD, NetBSD, OpenBSD, etc,), Linux distributions (e.g., Red Flat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries ActiveX, Java, Javascript, AJAX HTML, Adobe Flash, etc.), or the like.

In some embodiments, the computer system 401 may implement a web browser 418 stored program component. The web browser may be a hypertext viewing application, such as Microsoft Internet Explorer, Google Chrome, Manilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server may be an Internet mail server such as Microsoft Exchange, or the like. The mail server may utilize facilities such as ASP, ActiveX, ANSI C++/C#, Microsoft NET, CCI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail, Microsoft Entourage, Microsoft Outlook, Mozilla Thunderbird, etc.

In some embodiments, computer system 401 may store user/application data 421, such as the data, variables, records, etc, as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.), Such databases may be consolidated or distributed, sometimes among the various computer systems discussed above in this disclosure. It is to be understood that the structure and operation of the any computer or database component may be combined, consolidated, or distributed in any working combination.

As described above, the modules 206, amongst other things, include routines, programs, objects, components, and data structures, which perform particular tasks or implement particular abstract data types. The modules 206 may also be implemented as, signal processor(s), state machine(s), logic circuitries, and/or any other device or component that manipulate signals based on operational instructions. Further, the modules 206 can be implemented by one or more hardware components, by computer-readable instructions executed by a processing unit, or by a combination thereof.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

1. A method of enabling real time location based personalized offer management to a customer, said method comprising:
identifying, by a processor of a personalized offer management system, a plurality of potential customers likely visiting an establishment;
creating, by the processor, a segregated customer data (SCM) associated with the plurality of potential customers, wherein the SCM comprises historical data of one or more buying patterns (BP) and the one or more areas of interests associated with the plurality of potential customers;
mapping, by the processor, a plurality of personalized offers applicable on one or more products with the SCM;
determining, by the processor, a plurality of relevant personalized offers (RPO) based on mapping of the plurality of personalized offers with the SCM;
receiving dynamically, by the processor, information associated with presence of the plurality of potential customers within the establishment from an external device, based on current location (CL) of the plurality of potential customers; and
generating, by the processor, one or more real time recommendations of offer to the plurality of potential customers present within the establishment, based on one or more buying patterns and offer acceptance to the plurality of relevant personalized offers made to the plurality of potential customers.

2. The method as claimed in claim 1, wherein identifying the plurality of potential customers likely visiting the establishment comprises the steps of:
identifying the plurality of potential customers and determining one or more buying patterns (BP), real time customer activity (CA) and product interest (PI) of the plurality of identified potential customers;
estimating a customer convenience (CC) score based on the one or more buying patterns (BP), customer activity (CA), current location (CL), and product interest (PI) score of the plurality of potential customers thus determined along with past buying patterns and past customer activity;
determining a possibility of store visit (PSV) score for the plurality of potential customers based on the estimated CC score; and
comparing the determined possibility of store visit (PSV) score with a predetermined possibility of store visit threshold (PSVT) value stored in the customer data repository; and
identifying the plurality of potential customers likely visiting the establishment based on the comparison.

3. The method as claimed in claim 2, wherein identifying the plurality of potential customers comprising the steps of:
creating one or more customer records (CR) for one or more visitors to the establishment, wherein the CR comprises a plurality of responses corresponding to a plurality of predefined questions related to interest areas of the visitor;
calculating a relationship index (RI) associated with the one or more customer records based on the plurality of responses made by the one or more visitors;
comparing the calculated relationship index with a predetermined threshold relationship index stored in the customer data repository; and
identifying the one or more visitors as the plurality of potential customers based on the comparison.

4. The method as claimed in claim 1, wherein upon determining dynamically the presence of the plurality of potential customers within the establishment, the method comprising the steps of:
determining location of one or more offered products associated with the plurality of relevant personalized offers;
generating a navigation path (NP) to reach the one or more offered products based on store layout, determined location of the one or more offered products, and current location of the plurality of potential customers; and
displaying the generated NP on one or more devices associated the plurality of potential customers to navigate along the generated NP.

5. The method as claimed in claim 1, further comprising:
estimating customer activity (CA) in response to the plurality of relevant personalized offers by the plurality of potential customers present within the establishment;
determining whether the plurality of potential customers have used the relevant personalized offer based on the determined customer activity (CA) and offer acceptance to the plurality of relevant personalized offers; and
deriving offer usage by the plurality of potential customers based on the determination.

6. The method as claimed in claim 5, wherein generating one or more real time offer recommendations to the plurality of potential customers comprising the steps of:
determining real time product interest score associated with one or more areas of interest and real time buying patterns of the plurality of potential customers based on customer activity (CA) and past product interest score;
determining one or more alternate offers (AO) based on the real time product interest score and real time buying patterns thus determined; and
providing the one or more alternate offers (AO) to the plurality of potential customers.

7. The method as claimed in claim 1, further comprising:
determining real time campaign effectiveness index based on the real time offer usage, CA, SVI, AO, RI, PI and CC scores each SCM associated with the plurality of customers;
comparing the real time campaign effectiveness index thus determined with a predetermined threshold campaign effectiveness index;
modifying, based on the comparison, the customer convenience (CC), one or more customer records (CR), the SCM and determining a new product interest (PI) score based on store visit information, past buying patterns and past customer activity;
comparing the new product interest (PI) score with the past product interest (PI) score; and
determining one or more relevant personalized offers and one or more alternate offers based on the comparison.

8. A personalized offer management system for enabling real time location based personalized offer management to customer, said system comprising:
a processor;
a customer data repository, coupled with the processor, for storing segregated customer data (SCM) comprising historical data of one or more buying patterns (BP) and the one or more areas of interests of the plurality of potential customers; and
a memory disposed in communication with the processor and storing processor-executable instructions, the instructions comprising instructions to:
identify a plurality of potential customers likely visiting an establishment;
create the segregated customer data (SCM) associated with the plurality of identified potential customers;
map a plurality of personalized offers applicable on one or more products with the SCM;
determine a plurality of relevant personalized offers (RPO) based on mapping of the plurality of personalized offers with the SCM;
receive dynamically information associated with presence of the plurality of potential customers within the establishment from an external device, based on current location (CL) of the plurality of potential customers; and
generate one or more real time recommendations of offer to the plurality of potential customers present within the establishment, based on one or more buying patterns and offer acceptance to the plurality of relevant personalized offers made to the plurality of potential customers.

9. The system as claimed in claim 8, wherein the processor is configured to identify the plurality of potential customers likely visiting the establishment by performing the steps of:
identifying the plurality of potential customers and determining one or more buying patterns (BP), real time customer activity (CA) and product interest (PI) score of the plurality of identified potential customers;
estimating a customer convenience (CC) score based on the one or more buying patterns (BP), customer activity (CA), current location (CL), and product interest (PI) score of the plurality of potential customers thus determined along with past buying patterns and past customer activity;
determining a possibility of store visit (PSV) score for the plurality of potential customers based on the estimated CC score; and
comparing the determined possibility of store visit (PSV) score with a predetermined possibility of store visit threshold (PSVT) value stored in the customer data repository; and
identifying the plurality of potential customers likely visiting the establishment based on the comparison.

10. The system as claimed in claim 9, wherein the processor is configured to identify the plurality of potential customers by the steps of:
creating one or more customer records (CR) for one or more visitors to the establishment, wherein the CR comprises a plurality of responses corresponding to a plurality of predefined questions related to interest areas of the visitor;
calculating a relationship index (RI) associated with the one or more customer records based on the plurality of responses made by the one or more visitors;
comparing the calculated relationship index with a predetermined threshold relationship index stored in the customer data repository; and
identifying the one or more visitors as the plurality of potential customers based on the comparison.

11. The system as claimed in claim 8, wherein upon determining dynamically the presence of the plurality of potential customers within the establishment, the processor is further configured to:
determine location of one or more offered products associated with the plurality of relevant personalized offers;
generate a navigation path (NP) to reach the one or more offered products based on store layout, determined location of the one or more offered products, and current location of the plurality of potential customers; and
display the generated NP on one or more devices associated the plurality of potential customers to navigate along the generated NP.

12. The system as claimed in claim 8, wherein the processor is further configured to:
estimate customer activity (CA) in response to the plurality of relevant personalized offers by the plurality of potential customers present within the establishment;
determine whether the plurality of potential customers have used the relevant personalized offer based on the determined customer activity (CA) and offer acceptance to the plurality of relevant personalized offers; and
derive offer usage by the plurality of potential customers based on the determination.

13. The system as claimed in claim 12, wherein the processor is configured to provide one or more real time offer recommendations to the plurality of potential customers by performing the steps of:
determining real time product interest score associated with one or more areas of interest and real time buying patterns of the plurality of potential customers based on customer activity (CA) and past product interest score;
determining one or more alternate offers (AO) based on the real time product interest score and real time buying patterns thus determined; and
providing the one or more alternate offers (AO) to the plurality of potential customers.

14. The system as claimed in claim 8, wherein the processor is further configured to determine real time campaign effectiveness index based on the real time offer usage, CA, SVI, AO, RI, PI and CC scores each SCM associated with the plurality of customers;
compare the real time campaign effectiveness index thus determined with a predetermined threshold campaign effectiveness index;
modify, based on the comparison, the customer convenience (CC), one or more customer records (CR), the SCM and determining a new product interest (PI) score based on store visit information, past buying patterns and past customer activity;
compare the new product interest (P1) score with the past product interest (PI) score; and
determine one or more relevant personalized offers and one or more alternate offers based on the comparison.

15. A non-transitory computer readable medium including instructions stored thereon that when processed by at least one processor cause a system to perform acts of:
identifying a plurality of potential customers likely visiting an establishment;
creating a segregated customer data (SCM) associated with the plurality of identified potential customers, wherein the SCM comprises historical data of one or more buying patterns (BP) and the one or more areas of interests of the plurality of potential customers;
mapping a plurality of personalized offers applicable on one or more products with the SCM;
determining a plurality of relevant personalized offers (RPO) based on mapping of the plurality of personalized offers with the SCM;
receiving dynamically information associated with presence of the plurality of potential customers within the establishment from an external device, based on current location (CL) of the plurality of potential customers; and
generating one or more real time recommendations of offer to the plurality of potential customers present within the establishment, based on one or more buying patterns and offer acceptance to the plurality of relevant personalized offers made to the plurality of potential customers.

16. The medium as claimed in claim 15, wherein the at least one processor is configured to identify the plurality of potential customers likely visiting the establishment by performing the steps of:
identifying the plurality of potential customers and determining one or more buying patterns (BP), real time customer activity (CA) and product interest (PI) score of the plurality of identified potential customers;
estimating a customer convenience (CC) score based on the one or more buying patterns (BP), customer activity (CA), current location (CL), and product interest (PI) score of the plurality of potential customers thus determined along with past buying patterns and past customer activity;
determining a possibility of store visit (PSV) score for the plurality of potential customers based on the estimated CC score; and
comparing the determined possibility of store visit (PSV) score with a predetermined possibility of store visit threshold (PSVT) value stored in the customer data repository; and
identifying the plurality of potential customers likely visiting the establishment based on the comparison.

17. The medium as claimed in claim 16, wherein the at least one processor is configured to identify the plurality of potential customers by the steps of:
creating one or more customer records (CR) for one or more visitors to the establishment, wherein the CR comprises a plurality of responses corresponding to a plurality of predefined questions related to interest areas of the visitor;
calculating a relationship index (RI) associated with the one or more customer records based on the plurality of responses made by the one or more visitors;
comparing the calculated relationship index with a predetermined threshold relationship index stored in the customer data repository; and
identifying the one or more visitors as the plurality of potential customers based on the comparison.

18. The medium as claimed in claim 16, wherein upon determining dynamically the presence of the plurality of potential customers within the establishment, the at least one processor is further configured to:
determine location of one or more offered products to the plurality of potential customers;
generate a navigation path (NP) to reach the one or more offered products based on store layout, determined location of the one or more offered products, current location of the plurality of potential customers; and
display the generated NP on one or more devices associated the plurality of potential customers to navigate along the generated NP.

19. The medium as claimed in claim 16, wherein the at least one processor is further configured to:
estimate customer activity (CA) in response to the plurality of relevant personalized offers by the plurality of potential customers present within the establishment;
determine whether the plurality, of potential customers have used the relevant personalized offer based on the determined customer activity (CA) and offer acceptance to the plurality of relevant personalized offers; and
derive offer usage by the plurality of potential customers based on the determination.

20. The medium as claimed in claim 19, wherein the processor is configured to provide one or more real time offer recommendations to the plurality of potential customers by performing the steps of:
determining real time product interest score associated with one or more areas of interest and real time buying patterns of the plurality of potential customers based on customer activity (CA) and past product interest score;
determining one or more alternate offers (AO) based on the real time product interest score and real time buying patterns thus determined; and
providing the one or more alternate offers (AO) to the plurality of potential customers.

21. The medium as claimed in claim 16, wherein the at least one processor is further configured to:
determine real time campaign effectiveness index based on the real time offer usage, CA, SVI, AO, RI, PI and CC scores each SCM associated with the plurality of customers;
compare the real time campaign effectiveness index thus determined with a predetermined threshold campaign effectiveness index;
modify, based on the comparison, the customer convenience (CC), one or more customer records (CR), the SCM and determining a new product interest (PI) score based on store visit information, past buying patterns and past customer activity;
compare the new product interest (PI) score with the past product interest (PI) score; and
determine one or more relevant personalized offers and one or more alternate offers based on the comparison.
